(19) United States
(12) Patent Application Publication
(10) Pub. No.: US 2015/0231751 A1
(43) Pub. Date: Aug. 20, 2015

(54) Machine Tool Having Functional Components That Produce Heating During Operation

(71) Applicant: DECKEL MAHO Seebach GmbH, Seebach (DE)

(72) Inventor: Udo Tüllman, Eisenach (DE)

(73) Assignee: DECKEL MAHO SEEBACH GMBH, Seebach (DE)

(21) Appl. No.: 14/624,201

(22) Filed: Feb. 17, 2015

(30) Foreign Application Priority Data
Feb. 17, 2014 (DE) 102014202878.7

(51) Int. Cl. B23Q 11/12

(52) U.S. Cl. CPC B23Q 11/128

(57) ABSTRACT

Provided is a machine tool having functional components that produce heat during operation and which are arranged on a machine frame having cavity structures that form a circulation circuit in which a coolant is circulated inside the machine frame. The machine frame has first areas where the heat-generating functional components are arranged, and second areas spaced apart from the first areas. The heat input in the second areas, which is produced by the functional components, is smaller than that in the first areas. The cavity structures have first sections which are arranged in the first areas and second sections that are arranged in the second areas, and therefore, when the coolant is circulated from the first sections to the second sections, the heat supplied by the functional components is dissipated into the second areas so as to effect a temperature compensation between the first and second areas.

### CROSS-REFERENCE TO RELATED APPLICATIONS

This application claims priority to German Application No. 102014202878.7 filed Feb. 17, 2014, the entire contents of which is incorporated by reference herewith.

### FIELD OF INVENTION

Embodiments of the present invention relate to temperature control of a machine tool, comprising functional components that produce heat during operation and are arranged on a machine frame.

### BACKGROUND

On account of existing thermal expansion coefficients of the various modules and frame components, machine tools generally have a thermal growth during operation. The thermal growth results from the linear thermal expansion and from the temperature differences which are formed on the components of machine tools. The temperature differences in the frame of a machine tool result in a non-uniform expansion of the various components of the frame and thus, in an increased machining inaccuracy when a workpiece is machined. This increased machining inaccuracy is due to the temperature-related non-uniform curvature of the guideways on the machine bed of the machine tool, for example.

Heat-related expansion of a uniformly heated slide (1) of a conventional machine tool is shown in FIG. 1. The illustrated thermal growth here follows from the linear thermal expansion, on the one hand, and from the temperature differences in the components, on the other hand. The cause of the temperature differences is the non-uniform input of heat into the components of the machine tool. One side of the components is connected to guides or to drives, for example, and therefore the connected side is heated more strongly and faster than the unconnected opposite side. Thus, there is often the situation that a frame component of a machine tool has a warm and/or rapidly heating side where guideways and drives are placed and has a side which is cold and/or heats up more slowly and less strongly.

Uniform heating of the slide 1 leads to a uniform change in length, ΔL, and/or a uniform change in height, ΔH, as shown in FIG. 1. The uniformly heated slide (1) is guided on the guideway 3 on the machine bed 2, wherein due to the uniform heating the machining axes do not undergo a curvature. However, an absolutely uniform heating of the slide during the operation of the machine tool is usually not achieved in practice.

Compared thereto, FIG. 2 shows a slide (1) heated on one side. The slide (1) has an upper side and a lower side. The upper side is heated more strongly. As shown in FIG. 1, the slide (1) is guided along the guideways (3) and the movement along the guideways generates heat, and therefore the lower temperature difference, ΔT_top, is higher than the temperature difference on the upper side, ΔT_bottom, of the slide (1). The increased temperature difference on the lower side leads to a temperature-related extension, L_bottom, on the lower side, said extension being larger than that on the upper side, L_top, and thus causes the slide (1) to bend. As a result, the non-uniform heating of the slide (1) leads to a two-dimensional change in the longitudinal axis of the slide. The non-uniform heated slide 1 plus guideways and machine bed (2) is shown again in FIG. 3. The curvature of the slide (1) increases the machining inaccuracy of the machine tool due to the curved machining axis.

Various possibilities are known to reduce the resulting deformations of conventional non-uniformly heated machine tools.

A possibility of compensating the deformations on a non-uniformly heated machine tool is what is called the control-engineered compensation. According to this procedure, a temperature is measured and the change in the measured value is calculated with respect to a constant value, what is called the “compensation factor”. The thus determined value is adopted as a correction value in the axis control of the respective machine. However, this widely spread and generally common method of compensation has the drawback that the control-engineered compensation is unable to balance a thermal growth, the value of which depends on the axis position of the machine tool. Thus, bends of a non-uniformly heated component cannot be balanced. WO 2012/032423 A1 discloses a machine having such a compensating mechanism. In this publication, the deformation of the machine is determined via detection devices and a compensation of the determined deviations is then carried out via the correction apparatus.

A further possibility is the passive temperature control of a machine tool. This possibility is used above all in grinding machines. The respective grinding machines are usually made as flatbed machines. All slides and tool holders are arranged above the machine bed. The process coolant is not only supplied to the machining point but is also used to sprinkle the structures on the machine bed. This serves for avoiding a strong temperature difference between the machine components and thus a high thermal growth cannot develop. However, the effectiveness of this method is automatically limited when the respective machine is no flatbed machine. In this case, machine parts having large volumes are usually hidden behind covers which prevent direct wetting with the process coolant. This limitation thus applies to the by far major part of lathes and milling machines and also to large grinding machines. In addition, dry processing, i.e. machining without process coolant, is not possible with this type of passive temperature control of the machine tool. DE 41 32 822 A1 discloses such a cooling operation. Here, coolant is sprayed via a freely pivotable spray nozzle to predetermined sites of the machine tool to cool these sites.

Another possibility is offered by the active temperature control of the machine tool. In this case, a medium which is raised to a fixed temperature or to a temperature controlled in accordance with a reference variable is used to locally control the temperature of some of the components of the machine tool by means of a refrigerating machine. As a result, in particular the centers of heat production, such as spindles and drives, are cooled. DE 20 2012 003 528 U1 discloses a device for compensating the thermal deformations on a motor spindle. In this case, a coolant is actively cooled via a cooling unit and is guided via a cooling channel system around the modules to cool them. However, the drawback of the active temperature control has to be seen in the costs involved. A cooling capacity of one kilowatt is calculated to cost about 1,000 EUR. In addition, the cooling unit in the machine tool forms a new error source since failures can often occur in the harsh production environment. In addition, environmental factors act on the machine and the workpiece. For example, a major part of the machining operations is carried out with a process coolant which can be either an emulsion or a cutting oil. When this medium has a temperature differing from that of the coolant, this will more likely create temperature differences on the component. In addition to the active temperature control of the machine tool to a common level, the active cooling of the process coolant represents a high-tech solution which strongly increases the costs and the complexity of the machine.

As a matter of principle, said active and passive temperature controls also have the drawback that they cannot prevent the creation of temperature differences. For example, the merely one-sided cooling of a component, of course, leads to the very creation of temperature differences in these components.

### SUMMARY OF THE INVENTION

An object is to develop a machine tool of the generic type in such a way that the above mentioned drawbacks are avoided or reduced. Another object of the present invention is to reduce the creation of thermal displacements on the machine tool without major technical effort.

These objects are achieved by a machine tool as described herein by way of advantageous embodiments of the invention.

The machine tool has a machine frame accommodating functional components which produce heat during the operation. The interior of the machine frame contains cavity structures for creating a circulation circuit in which a coolant circulates inside the machine frame. The machine frame has first areas where the heat-producing functional components are arranged and second areas which are spaced apart from the first areas. The heat input produced by the functional components into the second areas is smaller than into the first areas, and the cavity structures have first sections which are arranged in the first areas and second sections which are arranged in the second areas. The cavity structures in the machine frame are dimensioned in such a way that during the circulation of the coolant from the first sections to the second sections the heat supplied by the functional components is dissipated into the second areas so as to effect a temperature compensation between the first and second areas. Due to the heat compensation effected by the circulation of the coolant from the first sections to the second sections, a cost-effective passive circulation temperature control of the machine tool can be achieved and the thermal displacements of the machine tool (in particular the bends) can be strongly reduced. Temperature differences between the warm and cold sides of the frame are compensated for or at least strongly reduced. Correspondingly, the bend of the respective modules is also avoided or strongly reduced, which also applies to the thermal displacement resulting therefrom. The machining accuracy of the machine tool is thus increased.

In contrast to the widely employed principle of the exclusive arrangement of the cooling channels directly at the heat generators, such as at the above mentioned spindle cooling, the channels according to embodiments of the invention are provided in both the heat-generating areas of the machine tool and the areas without heat generator. Unlike the prior art, no refrigeration machine is provided, but a temperature compensation takes place inside the machine frame as a result of the circulation of the coolant within the cavity structures. Therefore, although the overall temperature of the machine frame increases, the temperature differences inside the machine frame are reduced. Thus, the present invention breaks the prevailing principle that the machining accuracy of the machine tool can only be achieved by cooling the warm areas of the machine tool by using, according to the invention, the heat of the functional components to uniformly heat the entire machine frame, thus failing to dissipate it to a refrigeration machine in one-sided fashion.

The volume and geometry of the cavities can be dimensioned by selecting the surface of the cavity in such a way that a sufficient heat transfer is achieved between the material of the component and the medium. The broad fundamental rule may be to select the heat-transferring area in such a way that the amount of heat transferrable with a small temperature difference between material and medium corresponds to a multiple of the heat input into the component. A person skilled in the art is aware that on the basis of the selection of the machine frame material, in particular depending on the thermal conduction coefficient (and the heat transfer coefficient) of the selected material, on the basis of the output of the selected pump and the resulting maximum circulation speed of the coolant and the maximum heat input of the heat-generating functional components into the machine frame, the cross-sections of the holes and/or cavity structures and the position of the holes and cavity structures should be dimensioned in such a way that the desired maximum temperature gradient (of 5° C. and preferably 3° C. and most preferably 2° C.) can be achieved in the machine frame. In this connection, the properties (such as thermal capacity and viscosity) of the selected coolant should, of course, be considered as well. In addition, the required dimensions can be determined by routine test methods without any problems.

The machine tool can be designed in such a way that the first sections and the second sections of the cavity structures can form a closed circuit which can be fully arranged inside the machine frame.

The full arrangement of said circuit inside the machine frame further reduces the temperature differences in the machine frame since all the sections of the closed circuit are guided inside the machine frame so as to reduce the environmental influences on the circuit. As a result of this embodiment, it is also avoided to have to provide external connecting lines serving for transporting the coolant. Since the entire cavity structures are arranged inside of the machine frame, the efficiency of the passive circulation temperature control of the machine tool is further increased. In addition, the temperature compensation merely takes place via the machine frame without using a refrigeration machine. Since no refrigeration machine has to be used, it is possible to reduce the costs for avoiding technically related processing inaccuracies of the machine tool.

An advantageous embodiment of the machine tool comprises cavity structures which are formed at least in part from a rib structure of the machine frame. Since machine frames usually have a rib structure as a standard feature, the existing cavity structures of this rib structure can be used for the formation of the above mentioned cavity structures for guiding the coolant. Thus, already existing structures of the machine frame can adopt a plurality of functions so as to create a cost-effective passive circulation temperature control of the machine tool. As a result, the number of the required components can also be reduced and additional holes can be avoided, which, in turn, is efficient and cost-effective.

The machine tool can accommodate a coolant which can exclusively be temperature controlled via the machine frame. Since the coolant can exclusively be temperature controlled due to the heat transport from the first sections to the second sections via the machine frame, it is possible to create a cost-effective passive circulation temperature control for a machine tool. Therefore, the present temperature control does not require any active refrigeration devices which actively cool down the coolant with major effort and at high costs. In addition, it is thus possible to reduce the temperature differences in the machine frame since the otherwise unused areas of the machine frame can also be used for the temperature control.

The machine tool can be made as a portal machine. Here, the machine frame can consist of a machine bed and a column. The heat generating functional components may consist of a drive and guideways, and the first and second sections may be arranged in both the column and the machine bed.

An effective reduction in the temperature differences is possible by the arrangement of the first and second sections in the column and also in the machine bed. The deformations on the non-uniformly heated machine tools can be further reduced by the temperature control of the column and simultaneously also of the machine bed. In addition, it is also possible to dissipate the heat of the guideways.

The first sections of the cavity structures can be connected to the second sections of the cavity structures via through holes, and the openings of the through holes can be closed with covers on the external surfaces of the machine frame. These covers may be detachable so as to enable a particularly easy access to the cooling channels by removal of the detachable covers for the purpose of maintenance. In a particularly advantageous exemplary embodiment, the covers are partially or fully transparent due to the use of, e.g. glass or transparent plastic materials, and therefore a regular check of the cooling channels for calcification or dirt is possible without the removal of the cover.

By providing through holes for joining the cavity structures, it is possible to create a cost-effective and simple coolant circuit since the through holes can simultaneously join a plurality of cavity structures so as to reduce the number of holes. Open ends of the through holes can easily be closed by covers so as to prevent coolant from escaping. These covers can also be made so as to be removable, which enables a simple maintenance of the cavity structures.

The machine tool can have a machine bed and a column having cavity structures, and these cavity structures can communicate with one another in such a way that for compensating temperature differences the coolant can flow through the cavity structures of the column and of the machine bed. This design enables another reduction in the temperature differences because the coolant can flow from the cavity structures of the column into the cavity structures of the machine bed, thus forming a common circuit.

It is thus possible to circulate the entire coolant with only one pump. In a special exemplary embodiment, the machine bed and/or the column can consist of a cast mineral so as to achieve a particularly high damping effect and a high temperature stability. When cast mineral is used, the vibrations occurring during the operation of the machine tool can be damped 6 to 10 times faster than in the case of gray cast iron.

The machine frame of a machine tool according to certain embodiments may consist of gray cast iron. The gray cast iron can additionally have a high thermal conductivity of 30 to 60 W/(m·K), for example. The efficiency of the passive circulation temperature control of the machine tool is further increased by using gray cast iron having a high thermal conductivity. Moreover, the use of castings enables a simple integration of the cavity structures into the casting cores which have to be provided anyway. The perforations of the casting cores can additionally be provided as a connection between the different cavity structures. This serves for achieving another synergy effect, and the perforations of the core marks (core positioning), which are to be provided anyway when castings are produced, are used as communication channels of the cavity structures. This further reduces the costs and increases the efficiency of the passive circulation temperature control of the machine tool.

A machine tool according to certain embodiments may have cavity structures that are designed at least in part as cooling channels having circular and/or elliptic cross-sections. The use of circular or elliptic cross-sections (instead of, for example, square cross-sections) facilitates the movement and/or the flow of the coolant within the cooling channels. In addition, the number of edges in the cooling channels is thus reduced so as to also reduce the number of points in the cooling circuit where deposits can form. Furthermore, the use of circular or elliptic cross-sections can increase the structural strength, in particular the torsional rigidity, of the machine frame.

The machine tool can have cavity structures which are coated. The corrosion and algae formation can be reduced by coating the cavity structures. The internal coating of the cavity structures can preferably be based on a chemical nickel coating. In addition, the coating can also be applied via thermal spraying using atmospheric plasma spraying or electric arc spraying, for example, to obtain an intact layer. Advantageous surface roughness features and thin layer thicknesses can be achieved by the low layer porosity during thermal spraying. A protective layer of the coated cavity structures may range from 0.05 to 1 mm, or between 0.1 and 0.2 mm, and may have a roughness value Ra of 0.01-5 μm, or about 0.03-0.09 μm. A plurality of layers arranged on top of one another can also be available. The coolant flow in the cavity structures is strongly facilitated by the smooth surface.

In addition to said coolant, the machine tool can be operated with a process coolant. The temperature of the process coolant for directly cooling the work process can be matched with the temperature of the coolant via a heat exchanger. Another reduction in the temperature differences is enabled by matching the temperatures.

Moreover, the machine tool according to certain embodiments may have a heat exchanger which is designed as a plate heat exchanger. A plate heat exchanger enables a flat and space-saving installation in the machine tool.

A pump for adjusting the volume flow of the coolant within the cavity structures can be provided and the output of the pump and the cross-section of the cavity structures may be such that the maximum temperature difference of the coolant within the machine frame between the first sections and the second sections is limited during the operation to below 5° C., preferably below 2° C.

The inner surfaces of the cavities can be dimensioned in such a way that the maximum temperature difference of the slowly circulated (e.g. with a circulation rate of less than 40 l/min) coolant in the first and second sections is below 2° C. Depending on the maximum heat of the heat-generating functional components, the inner surfaces of the cavities can thus be designed in such a way that a uniform temperature distribution can be ensured during the operation of the machine tool.

In certain embodiments, the ratio between the volume of the cavity structures (the so-called “cavity volume”) for accommodating the coolant to the volume of the respective frame component (“spatial volume”) where the respective cavity structures are found, preferably ranges from about 2:1 to about 1:3 (frame component volume to cavity structure volume of the respective frame component). Thus, the respective cavity structure volume is at least twice as high as the volume of the frame component. Since the cavity structures have at least twice the volume of the machine frame, it is possible to increase the internal heat transport in the machine frame without having to raise the circulation rate of the coolant. The temperature difference in the component is thus further reduced without having to raise the pump output.

The machine tool may comprise as a heat-generating functional component a transmission in addition to the guideways and drives. Due to the consideration of the transmission for the heat-generating functional components and the resulting heat dissipation, it is also possible, in the case of machines having a transmission, to dissipate the heat of the transmission so as to further reduce the temperature differences in the machine frame.

Cavity structures of the machine bed may be arranged in parallel below the guideways and the column can merely have second areas. The arrangement of the cavity structures directly and parallel below the machine bed and the simultaneous, exclusive provision of second areas in the column lead to an effective heat dissipation from the machine bed into the cold column.

Embodiments of the invention also relate to a method for controlling the temperature of the machine frame of a machine tool having functional components that generate heat during the operation and which are arranged on the machine frame that has cavity structures forming a circulation circuit where a coolant circulates. The method comprises steps of circulating the coolant in the circulation circuit from the first sections to the second sections and back and of absorbing the heat through the coolant in the first sections and dissipating the heat in the second sections, wherein the coolant can distribute the heat exclusively in the machine frame. It is thus possible to achieve an efficient temperature control of the machine tool frame without using a refrigeration machine.

In this connection, the method may include the additional steps of circulating the coolant for compensating temperature differences from cavity structures of the column into those of the machine bed and back or vice versa. It is thus possible to achieve an efficient temperature control of the machine tool frame.

The method may include the steps of pumping the coolant through the first sections of the first areas of the cavity structures of a machine bed of the machine frame and of pumping the coolant into the second sections of the second areas of the cavity structures of a column of the machine portion of the machine tool and back and of pumping, in a further step, the coolant into first sections of the cavity structures of a crossbar of the machine portal and then back into the second sections of the cavity structures of the column of the machine portal. It is thus possible to achieve an effective temperature control of the machine tool frame since the temperature differences can be further reduced.

By matching the temperature of the process coolant which can directly cool the machined area of the workpiece during the work process with the temperature of the coolant via a heat exchanger, it is possible to achieve an even more efficient temperature control of the machine tool frame since the temperature differences can be further reduced.

In embodiments, the method may include circulating the coolant from cavity structures of a column into the cavity structures of the machine bed and back and/or of circulating the coolant from cavity structures of the column into cavity structures of a crossbar and back. It is thus possible to achieve an efficient temperature control of the machine tool frame since the temperature differences can be further reduced.

The machine tool according to certain embodiments may also comprise temperature sensors. The temperature sensors can be arranged in the first and second areas of the machine frame, and therefore the temperature difference between the areas can be monitored and it is possible to control the volume flow of the coolant as a function of the measured temperature. The volume flow can be controlled via the pump in such a way that depending on the inputted heat of the functional components the maximum temperature gradient can be achieved in the machine frame (of 5° C. and preferably 3° C. and most preferably 2° C.), wherein the temperature gradient is determined on the basis of the measured temperatures in the first and second areas, and therefore the deformation of the machine frame can be reduced with high precision. Alternatively or additionally, it is possible to measure the deformation of the frame via strain gauges and control the volume flow on the basis of the measured deformation (in particular the non-uniform deformation), thus reducing the non-uniform deformation to the desired degree.

Advantageous embodiments and further details of the present invention are described below by means of the different exemplary embodiments with reference to schematic drawings. The passive circulation temperature control of the machine tool is explained in more detail in the schematic drawings.

### BRIEF DESCRIPTION OF THE DRAWINGS

FIG. 1 shows a uniformly heated slide of a conventional machine tool.

FIG. 2 shows a non-uniformly heated slide of the machine tool.

FIG. 3 shows a non-uniformly heated slide on the guideways of the machine bed.

FIG. 4 shows the movement of the non-uniformly heated slide along the guideways.

FIG. 5 shows a machine tool having non-uniformly heated machine tool modules.

FIG. 6 shows the displacement of measurement points on the basis of the axis travel as a function of time.

FIG. 7A shows a portal machine having a plurality of slides.

FIG. 7B shows an enlarged detail of the frame of the portal machine.

FIG. 8A shows the position of section A-A through the column of the portal machine.

FIG. 8B shows section A-A.

FIG. 9A shows the position of section B-B on the portal machine.

FIG. 9B shows section B-B.

FIG. 10 shows the course of the coolant through the entire machine.

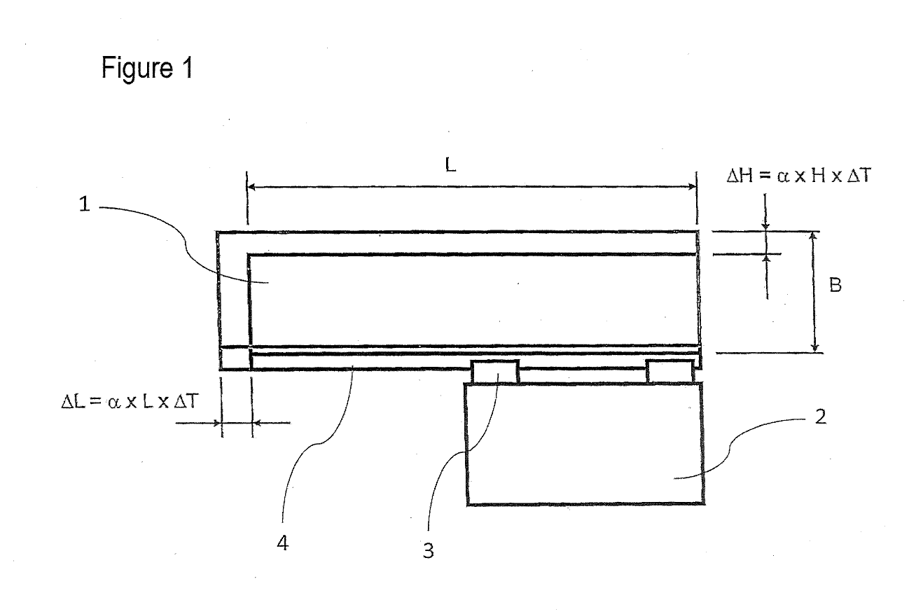

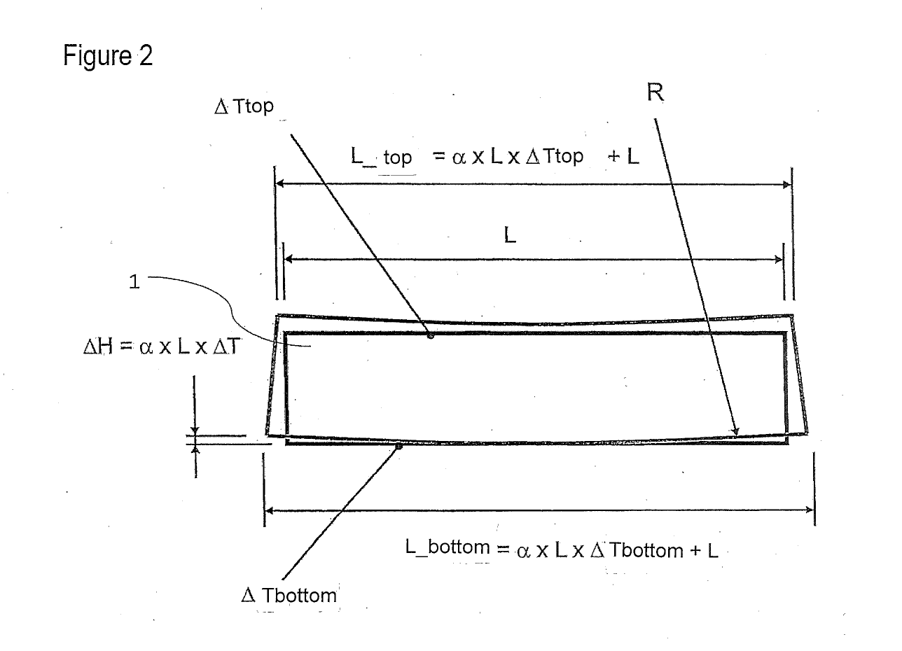

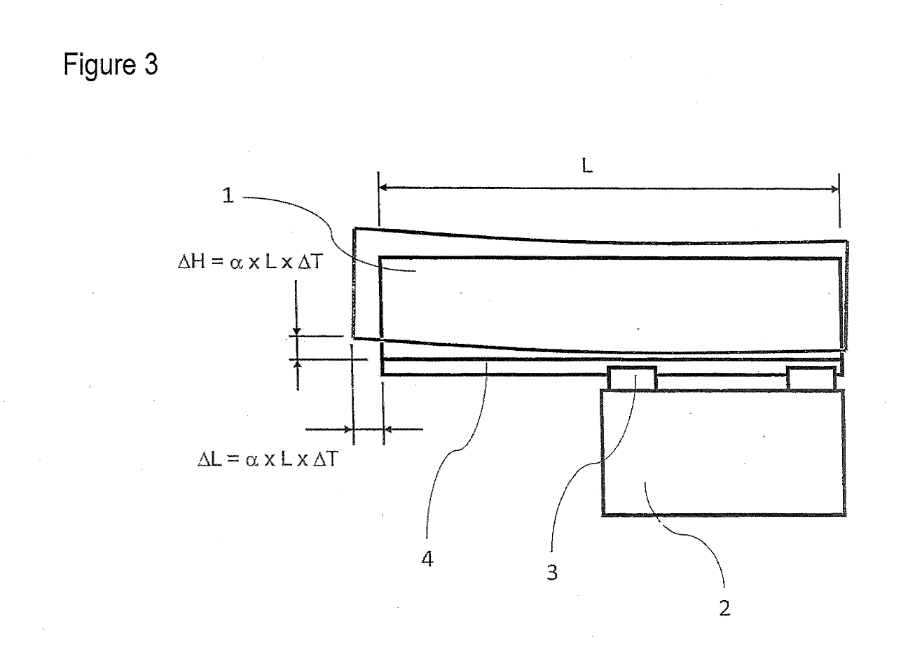

### DETAILED DESCRIPTION

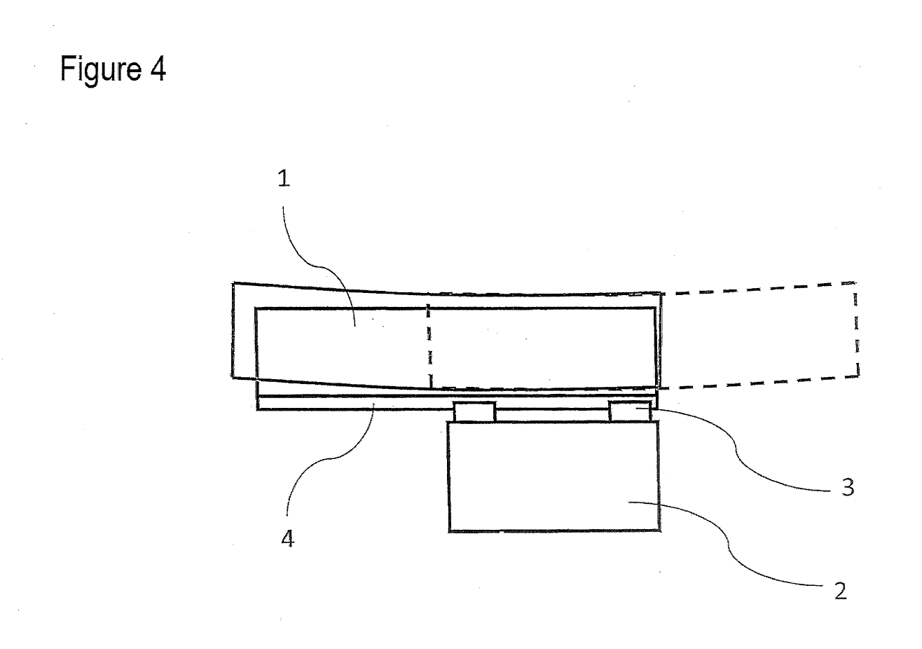

In order to illustrate exemplary effects of non-uniformly heated components of the machine tool, FIG. 4 shows the schematic movement of the non-uniformly heated slide (1) along the guideways (3). The non-uniformly heated slide (1) no longer performs a straight movement but travels along an arc. The dotted position of the slide (1) in FIG. 4 represents the second maximum deflection position of the slide 1 while the illustration of the slide (1), shown by a solid line, depicts the non-uniformly deformed tool slide in another maximum position. The unheated slide (1) is shown in its initial position in FIG. 4 for the purpose of comparison. In particular by means of the outer edges of said slide in the various maximum positions, the effect of the non-uniform heating of the slide 1 on the achievable movement accuracy of the slide can well be seen. Thus, the movement accuracy of the slide (1) strongly depends on the existing temperature difference.

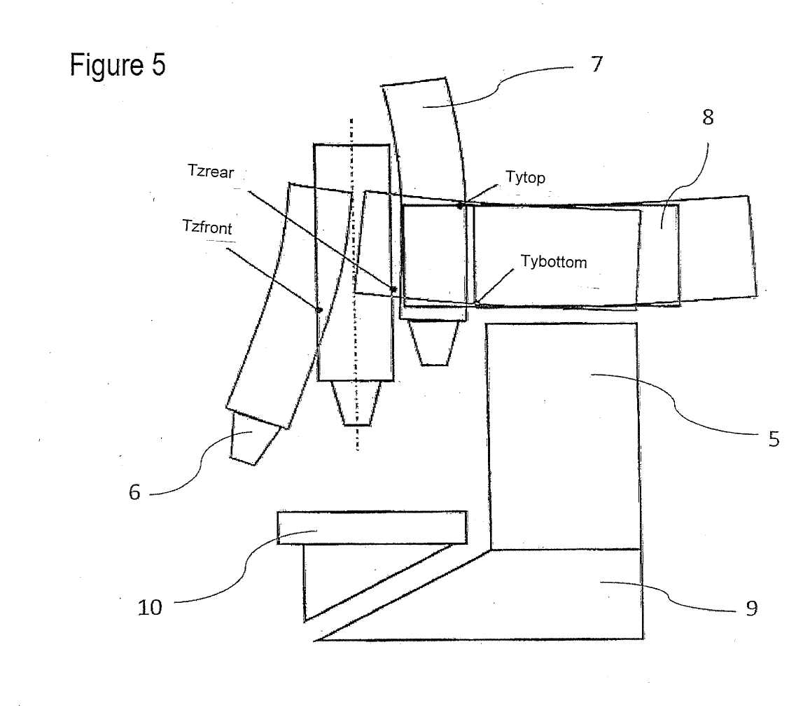

FIG. 5 illustrates an example of the deformations of a non-uniformly heated machine tool. Here, FIG. 5 does not only show the deformations of one but of two non-uniformly heated components of the machine tool, namely the headstock (7) and the longitudinal slide (8). However, the present invention is here not limited to the machine illustrated in FIG. 5, but may be used for any machine tool, such as lathes, drawing machines, mechanical presses, production machines and machine tools having multi-spindle or multi-slide designs. In this regard, both dry machining and wet machining are possible.

The machine shown in FIG. 5 comprises a column (5) which carries the longitudinal slide (8) and is arranged on the machine base (9). The machine table (10), on which a workpiece can be placed, is connected to the machine base (9) via an inclined guideway. The headstock (7) with the spindle (6) is guided along the vertical guideway of the longitudinal slide 8. FIG. 5 illustrates the basic position of the machine tool in the cold state, on the one hand. In the basic position, neither the headstock (7) nor the longitudinal slide (8) is deformed. These devices are orthogonal to each other in the basic position. In the case of a non-uniform heating of the headstock (7) with the spindle (6) and the longitudinal slide (8), a non-uniform deformation of these components takes place. The deformations of the components add up. This leads to an arc-shaped deformation as shown in FIG. 5. However, the deformations of said machine tool modules are exaggerated in FIG. 5 for the purpose of elucidation.

The effects of the non-uniform heating of the modules of the machine become apparent above all in the extreme positions of the machine tool. To this end, FIG. 5 shows the first maximum position, on the one hand, and a second maximum position, on the other hand. In the first maximum position of the machine tool, the longitudinal slide (8) is extended as much as possible in the direction of the machine table (10) and the headstock (7) is lowered along the vertical guideway as much as possible in the direction of the machine table 10. The non-uniform deformations of the longitudinal slide 8 and of the headstock (7) add up. The second maximum position corresponds to the upper maximum position. This position is characterized in that the longitudinal slide (8) is retracted as much as possible in the direction of the column 5, and the headstock (7) is in its uppermost position along the vertical guideway. However, the deformations of the longitudinal slide (8) and of the headstock (7) add up only in a very small part in this upper maximum position.

Particularly in the case of machines having large protrusions, i.e., long travels, major thermal growth result from the above described effects and constitute a large part of the inaccuracies which are left on the workpiece.

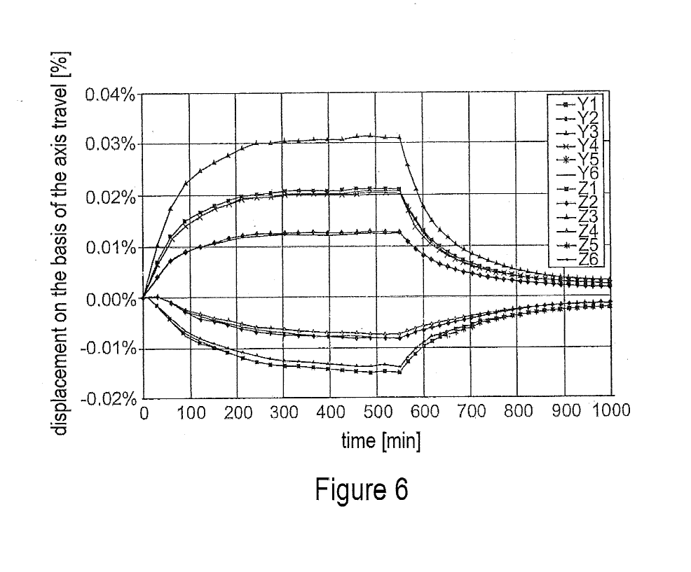

FIG. 6 shows the shares in the deviation at the tool tip, said shares having been determined by measurements. The deviations on the travel of the machine are standardized. Although the measured displacement is only between about 0.15 and 0.3%, this amounts to about 100 to 150 μm with a travel of 500 mm.

The described effects, of course, increase with the dynamics of the machine tool since the friction in the drive and guide elements and the resulting heating increases with the acceleration, and above all with maximum speed. Since attempts have been made for a long time to reduce the machine running times and non-productive times, and thus the unit costs regarding the machining operation, by increasing the dynamics of the machine axes, the described effects automatically increase with every machine generation. As a general rule, increasing protrusions result in increasing displacements. Thus, the formation of temperature differences in a processing machine represents the majority of thermal displacement. In this case, the temperature level merely plays a minor part. The precondition for maximum machining accuracy does not only lie with a machine, the components of which have a certain, accurately set temperature but simply only with a machine the components and workpieces of which have an equal temperature level.

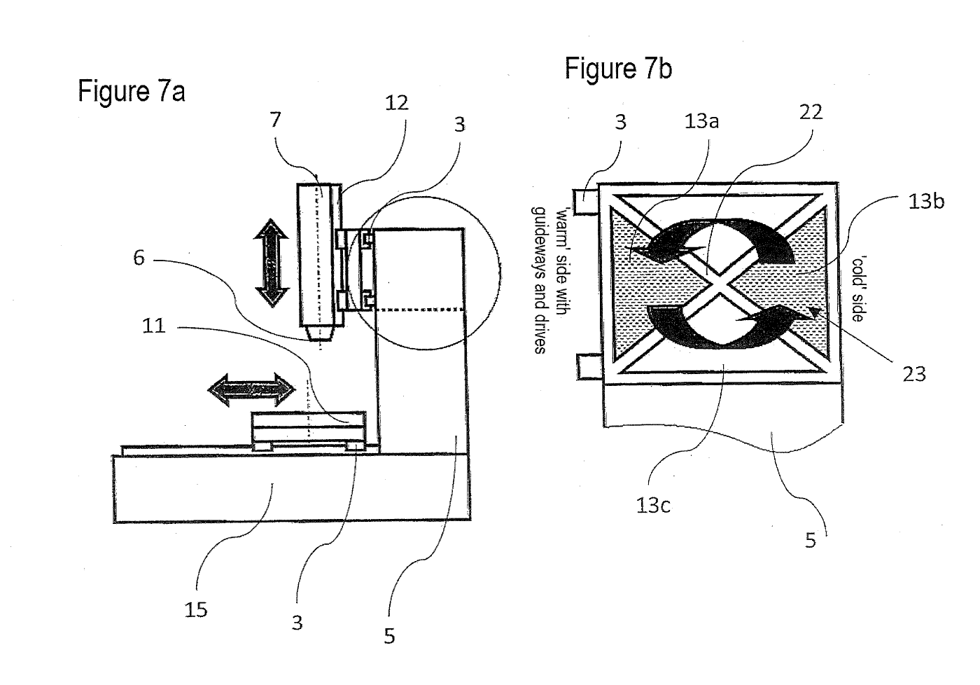

FIGS. 7A and 7B show one embodiment of the present invention. The frame components of the machine tool are here provided with cavities. In the case of cast components, this is achieved by a corresponding ribbing design. The cavities are arranged in such a way that they are disposed, on the one hand, on the side of the frame component where the guiding and drive elements are accommodated and, on the other hand, on the respectively opposite side of the frame component where no heat is supplied. Where appropriate, the cavities can be designed in such a way that a cavity has a connection to both the drive side and the opposite side. All cavities are filled with a fluid that has a high thermal capacity and a good thermal conductivity. This fluid is circulated at a low speed and temperature differences in the frame component are compensated for by circulating the fluid. This stops the above mentioned bend which is created due to temperature differences on the frame components. When a plurality of frame components is designed correspondingly, the cavities can be interconnected and the fluid can be circulated through all cavities by only one pump. This is a simple solution for compensating temperature differences in the frame of the machine tool and additionally avoids the formation of a majority of thermal displacements which occur on machine tools. It is here preferred for the machine frame of the machine tool to be made of gray cast iron, wherein the machine frame can here be understood to mean the sum of all supporting machine parts. In addition, the cavities have a large cross-section to accommodate a large amount of cooling fluid which is then circulated at a slow rate. The circulation amount preferably ranges from 5 to 50 liter/minute, for example (preferably 10 to 40 liter/minute) to absorb the resulting thermal conduction of the machine tool and thus guarantee a particularly uniform temperature control of the machine frame and simultaneously keep the pump output as low as possible. A 3-axis machine having a power input of 30 kW must dissipate a heat output of approximately between 2 and 6 kW into the circulation cooling in order that the coolant does not heat up excessively on the “warm” side of the machine. Thus, about 50 to 150 W heat output is supplied to the machine structure per kW of installed output power. In the present case, this can be achieved merely by the internal heat compensation in the frame of the machine tool.

The machine tool shown in FIG. 7A comprises guideways (3), a column (6) and a plurality of slides. This figure shows, on the one hand, a slide for movement along the vertical axis, Z-slide (12), and, on the other hand, a slide for movement along the horizontal axis, X-slide (11). The spindle (6) is arranged on the headstock (7), which is guided above the Z-slide (12) and the guideways (3) along the column (5). The X-slide (11) is guided via guideways (3) along the machine bed 15. The cavity structures are preferably arranged directly in the frame near the connecting sides to the guide and drive elements of the machine tool where they directly absorb the resulting heat.

The approach underlying the invention is to stop the creation of temperature differences on the frame components of machine tools without bringing them to a certain temperature by means of great technical expense. The thus provided cavities (13a), (13b) of the frame components are shown in FIG. 7B, for example. Part of these cavities is attached in the vicinity of the heat sources, i.e. on the warm side of the heat-generating functional components, such as guideway or drives (cavities having first sections (13a)) in such a way that a heat flow can be created between the cavity filling medium which has a good thermal conduction and a high thermal capacity and the heat sources, through which the medium absorbs the lost heat from the heat sources thus heating up as such. The other part of the cavities (cavities having second sections (13b); cold side) is arranged on the cold side of the frame component, which faces away from the heat sources, and is also filled with a medium having good thermal conduction and high thermal capacity. It is also possible that some cavities do not absorb the coolant (23), namely what is called the “free cavities” (13c). In another embodiment, it is also possible for the first and second sections (13a) and (13b) of the cavities to be disposed jointly in a cavity. The heat from various areas of the machine tool frame is balanced by the present invention, thus adjusting the temperature of the machine frame independently of a refrigeration machine. As a result, the coolant is not temperature-controlled in an active fashion but only passively by passing through the cavities of the machine frame without leaving it. Therefore, the coolant distributes the heat fully within the machine frame. In this connection, a symmetric arrangement of the cavities on the warm side and the cold side of the machine frame is particularly advantageous. The greater distance between the “warm” and “cold” cavities from one another, the better is the achieved temperature balancing effect in the frame. Thus, no expensive compressor or evaporator circuits are required in the present case, and therefore the temperature of the coolant is exclusively controlled by the machine frame, or the coolant exclusively dissipates and/or absorbs heat via the machine frame.

The medium is constantly but slowly circulated between these cavities having the first and second sections (13a) and (13b), and therefore the heat absorbed by the medium on the warm side is transported to the cold side where it heats the surrounding parts of the frame component. As a result, the temperature differences between the warm and cold sides are balanced or at least strongly reduced. Thus, the bend of the machine frame is also avoided or strongly reduced, which also applies to the thermal displacement resulting therefrom.

This procedure makes use of the effect that cast or welded parts, which are often used for the machine frame to form the frame components of the machine tool, are made as ribbed hollow bodies anyway. The given ribbing (22) (rib structure) is adapted so as to create the desired cavities for receiving the coolant (23). Possibly necessary core holes may be closed by covers. These covers can also be made in a detachable manner so as to ensure a simple access to the cavities in case of maintenance work.

FIG. 7B illustrates the schematic heat exchange between the warm side with the guideways and drives of the machine frame, and the column (5) with the cold side. The symbolic dark arrows shall here symbolize the coolant circulation. FIG. 7B additionally illustrates the ribbing (22) in the interior of the machine frame. The cavities here utilize the natural shape of the ribbing (22) of the machine frame. This serves for ensuring a very simple option for the configuration and arrangement of the cavities.

The given ribbing (22) is used, on the one hand, to form the cavities in the cast part and, on the other hand, to increase the reinforcement and rigidity of the frame components. The cavities are filled with water. The water is here circulated between the cavities so as to balance the temperature of the different sides of the cast part. The introduction of the water into the cavities of the machine frame additionally has a damping effect for the machine frame, and therefore the machining accuracy of the machine can be further increased.

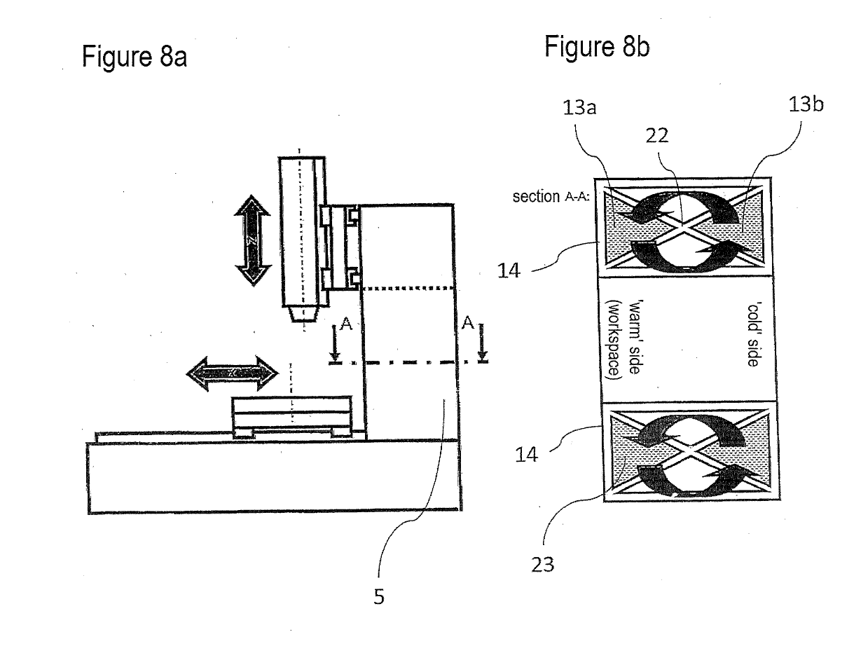

FIG. 8A shows the intersecting line A-A through the portal machine having two guide blocks. FIG. 8B shows section A-A. The two vertical column bars (14) of the portal machine here contain respective cavities of their own. The temperature control of the two column bars (14) effects in the portal machine a particularly high machining accuracy since an inclination of the crossbar is ensured by the uniform heating of the column bars (14). Another increase in the machining accuracy of the portal machine can be achieved by a thermally symmetric design of the column bars (14) and/or the entire machine frame. Here, a thermally symmetric design of all guideways is particularly advantageous.

If non-metallic materials are used for producing the frame components, e.g. cast mineral, corresponding channels are embedded in the casting. They differ from the quite known solutions of active cooling of cast mineral in that large cross-sections are chosen for the inserted tubes to achieve a good heat transfer. A coolant (23) which is not actively cooled is then also filled into these large cavities and is slowly circulated.

A particularly high machining accuracy of the machine tool according to certain embodiments can be obtained when all frame components of the machine tool are provided with the cavities for guiding the coolant. If according to the invention many of the frame components of the machine are provided with said cavities and the medium is not only circulated between the warm and cold sides of a component but additionally also between the cavities of the different frame components, the creation of temperature differences over the entire machine tool can be avoided or strongly reduced. The coolant is circulated through all frame components in a closed circuit. If a coolant system is present, the coolant can be raised to the temperature of the process coolant by simple means, e.g. a heat exchanger.

In the temperature control by circulation of the coolant through the machine tool or through the entire machine, the volume flow (preferably within the range of 40 l/min) must be designed in such a way that the supply of the heat flow resulting on the warm side only leads to a minimum temperature increase of e.g. below 2° C. in the medium and thus in the component.

It can thus be assumed by means of estimation that a frictional force of several dozen to several hundred Newton has to be overcome for each linear guideshoe. This frictional force depends on the size of the guideshoe, on the gasket, the bias and the load. Multiplied by the travel speed, the frictional force yields the friction power. The friction power for a guideshoe is therefore between 50 W and 200 W with an estimation of 50 m/min.

A drive may convert about 35% of the electric energy into heat, and about half of the heat is supplied to the machine structure. Thus, about between 50 and 150 W heat output are supplied to the machine structure per kilowatt of installed driving power.

A three-axis machine having a power input of 30 kW thus yields a heat output of approximately between 2 and 6 kW which has to be absorbed by the circulation cooling without the coolant heating excessively on the warm side. This heat output can be dissipated with a water circulation amount of about 10 to 40 l/min.

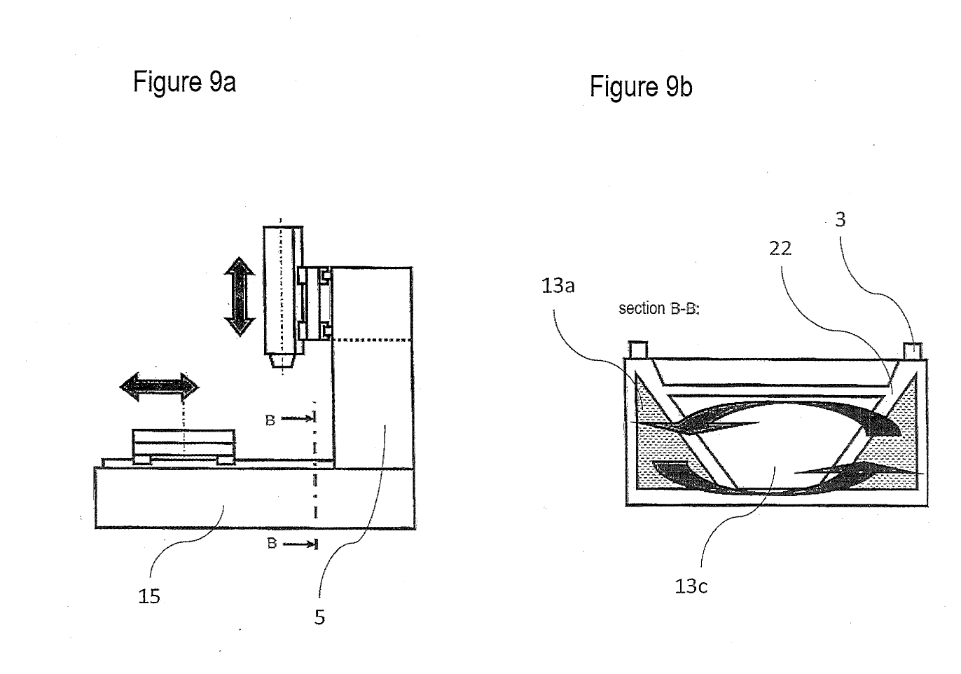

FIG. 9A shows the extension of section B-B according to an embodiment of the machine tool. FIG. 9B illustrates section B-B. The heat which is transferred on one side to the machine bed (15) via the guideway (3) is here balanced with the cold side of the machine bed (15) via the cavities along the schematic coolant flow arrows in FIG. 9B. The cavities are here selected so as to create a model and uniform heating of the machine bed (15). Coolants are thus not supplied directly to the middle cavity in FIG. 9B. A uniform temperature distribution or a uniform temperature of the upper side and the lower side of the machine bed is achieved by the heat compensation shown FIG. 9B).

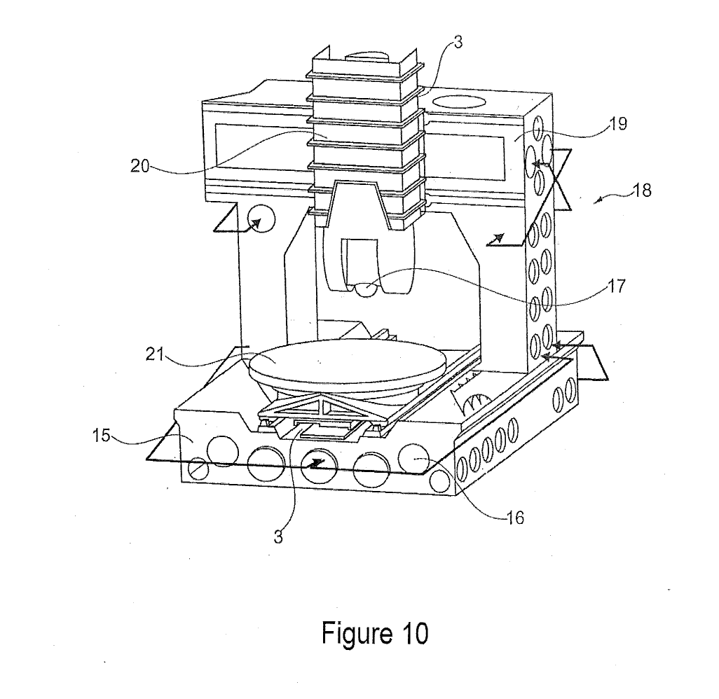

FIG. 10 shows a portal machine, wherein the temperature is controlled by the circulation of the coolant (23) through the entire machine. The course of the coolant (23) in the machine frame is shown by way of diagram using arrows. The portal machine in FIG. 10 may comprise guideways (3), which are arranged on the machine bed (15). The machine table (21) is connected to the machine bed (15) via the guideway (3). The cavity structures (16) in FIG. 10 may also be made as core holes. These holes are partially made as perforations. The uniform arrangement of the cavity structures (16) or the holes along the entire machine frame results in the most uniform temperature of the entire machine frame during the operation. It is preferred for the different holes on the machine frame or on all modules of the machine frame to use the same core cross-section of the drill, e.g., in the range of from about 25 mm to about 140 mm, to ensure a production operation of the machine which is as efficient as possible. It is particularly preferred for the cavity structures (16) to be arranged symmetrically along the component axes so as to create a particularly uniform heating of the machine tool. Component axes are here understood to mean the axes along which the clamped component can be moved along the guideways or along which the clamped component can be machined. Therefore, the axes are dependent on the position of the guideways and the position and moving direction of the drive units.

The machine in FIG. 10 additionally comprises a crossbar (19), a support (20) and a milling head (17). When a pump is arranged for circulating the coolant in the cavities, the shape of the machine portal (18) or the cavity structures (16) can be considered as well. It is thus possible to arrange the circulation pump in such a way that convection flows of the coolant can be utilized advantageously.

The portal machine in FIG. 10 contains a plurality of holes that create the cavity structures (16) together with the rib structure of the machine frame. First core holes (24) and second core holes (25) are arranged on the right-hand and left-hand side surfaces of the machine portal (18), i.e., on the vertical bars of the column of the machine tool, and are oriented in parallel, thus enabling the circulating coolant to flow through the frame to a particularly high extent so as to achieve a high heat compensation. In addition, the first core holes (24) and the second core holes (25) are arranged in parallel to the horizontal component machining axis of the machine tool. The first core holes (24) and the second core holes (25) extend from the left-hand side surface to the right-hand side surface of the machine portal 18 or vice versa and are thus parallel to the base of the machine tool or also parallel to the crossbar (15). The third core holes (26) are arranged along the axis of the work spindle or along the moving axis of the support (20), i.e., in the vertical direction of the machine tool since it is thus possible to absorb the heat generated by the spindle in a particularly good fashion. The crossbar (19) of the machine portal (18) additionally contains tenth core holes (38) which extend along and/or parallel to the longitudinal axis of the crossbar (19). Horizontal ninth core holes are provided from the front side to the rear side of the machine portal (18).

Fourth core holes (27) and fifth core holes (28) are arranged on the right-hand and left-hand side surfaces of the machine bed (15). These core holes extend horizontally through the machine bed (15) and parallel to the longitudinal axis of the crossbar (19). The fourth core holes (27)—the illustrated exemplary embodiment showing five bores of the fourth core holes (27)—are arranged at uniform distances directly below (vertically below) the guideways (3) of the machine table (21) to absorb the generated heat of the guideway (3) and of the component (not shown) which is installed thereon. The eighth core holes (31) are disposed in the lower right-hand and left-hand corner region of the machine bed (15) and extend horizontally, i.e., parallel, to the base of the machine tool. The eighth core holes (31) are geometrically spaced apart from the heat generating functional components, such as guideways or drives, of the machine tool as much as possible, thus forming compensation or balancing areas of the machine bed (15), and therefore the circulated coolant can dissipate the heat absorbed in these areas into cooler areas of the machine bed. The eighth core bores (31) are preferably always arranged in the outer corner regions of the components of the machine tool frame so as to be able to reach even the coldest areas of the components of the machine tool frame and to heat the machine tool frame as uniformly as possible.

The sixth core holes (29) and seventh core holes (30) and (33) are guided horizontally from the front side of the machine bed (15) to the rear side of the machine bed 15 (not shown) and are thus arranged parallel and in the direct vicinity to the guideways (3) of the machine table (21). The sixth core holes (29) are here made particularly large to absorb in the most efficient way the heat of the adjoining heat-generating functional components. All core holes preferably extend in such a way that they always intersect at right angles so as to ensure a simple production of the holes of the machine tool frame with some few work steps without frequently reclamping the frame components in the manufacturing process.

The horizontal arrangement of the core holes has as an advantage that the coolant can be pumped through these holes in a particularly easy way. The holes which are referred to herein as core holes can also be made as through holes or as blind holes. Penetrations are also possible instead of core holes. In the case of through holes, threads can be provided on the outer sides of the through hole so as to simply screw on the necessary closure cover and simply screw off the covers for the maintenance of the cavity structures (16).

The coolant is supplied from the column of the machine portal (18) via the machine bed supply (34) and directly into the sixth core holes (29) to the areas having the maximum heat input of the machine bed (15). This supply can be carried out by internal or external compensation lines (arranged in the machine frame or outside) of the machine frame, which are shown in FIG. 10 by way of diagram using flow arrows for the coolant. The core holes can also be designed in such a way that they adopt the function of compensation lines, as a result of which no additional lines are necessary. The coolant is supplied from the machine bed (15) via the first column supply (37) to the column of the machine portal. The coolant heated in the machine bed dissipates the heat in the column again and heats the latter. In the next step, the coolant which has dissipated the heat is supplied via the crossbar supply (36) to the cavity structures (16) of the crossbar. In the crossbar, the coolant absorbs the heat of the guideways (3) and of the support (20). In the next step, the coolant is supplied via the second column supply 36 to the column of the machine portal (18) where the coolant dissipates the heat again. As a result, the circuit starts from the beginning in the next step. Of course, the circuit can also be operated in the reverse way. The circulation of the coolant can here be carried out by one or several pumps.

If these preconditions are met, there is the possibility according to the invention to obtain the temperature control of the machine components by the simplest means. What is required is only a simple, constantly circulating circulation pump. A complicated control susceptible to failure is avoided. Compressor and evaporator circuits, as common in active cooling devices, or heat exchangers can be avoided as well. After all, the machine components shall not be cooled but rather the creation of temperature differences in the components is to be avoided.

If the machining process is supported by process coolants, it is useful according to embodiments the invention to adjust the temperature of the process coolant to that of the machine coolant. This can be achieved in a cost-effective and robust way by using a compact plate heat exchanger through which the two media flow.

Frame components of the machine tool according to certain embodiments comprise cavities having a noteworthy large cross-section compared to the dimensions of the frame component and a noteworthy large surface area compared to the surface area of the frame component, which accommodate a non-active temperature controlled coolant. The coolant (23) is circulated between these cavities to transport the amount of heat absorbed on the drive side to the opposite side of the frame component where it is dissipated so as to adjust in the component an overall higher but constant temperature level with strongly reduced temperature differences between the drive side and the side facing away therefrom and to stop the thermal deformations which bend the frame components. In this connection, it is possible to utilize the natural rib structure which metallic cast or welded frame components have for reasons of rigidity to form the cavities. Heat-generating functional components the heat of which can be dissipated are motors, transmissions, guideways or other modules which heat up during the operation, for example.

The present features, components and specific details can be exchanged and/or combined to create further embodiments depending on the required intended use. Possible modifications which are within the knowledge of a person skilled in the art are implicitly disclosed with the present description.

What is claimed is:

1. A machine tool, comprising:
a machine frame in which functional components are arranged that produce heat during the operation, said machine frame having:
cavity structures for forming a circulation circuit in which a coolant is circulated inside the machine frame;
first areas where the heat-generating functional components are arranged; and
second areas spaced apart from the first areas,
wherein
a heat input in the second areas, which is produced by the functional components, is smaller than that in the first areas,
the cavity structures have first sections arranged in the first areas and second sections arranged in the second areas, and
the cavity structures in the machine frame are dimensioned such that, when the coolant is circulated from the first sections to the second sections, heat supplied by the functional components is dissipated into the second areas so as to effect a temperature compensation between the first and second areas.

2. The machine tool according to claim 1, wherein the first sections and the second sections of the cavity structures form a closed circuit fully arranged inside the machine frame, and the temperature compensation only takes place via the machine frame without the use of a refrigeration machine.

3. The machine tool according to claim 1, wherein the cavity structures are formed at least in part from a rib structure of the machine frame.

4. The machine tool according to claim 1, wherein the coolant is exclusively temperature controlled due to the heat flow via the machine frame from the first sections to the second sections.

5. The machine tool according to claim 1, wherein:
the machine tool is configured as a portal machine,
the machine frame comprises a machine bed and a column,
the heat-generating functional components comprise a drive and guideways, and the first and second sections are arranged in the machine bed and/or in the column.

6. The machine tool according to claim 1, wherein the machine frame comprises a machine bed and a column, the machine bed and the column having cavity structures that communicate with one another in such a way that, for the purpose of compensation of temperature differences, the coolant flows from the cavity structures of the column into those of the machine bed and back or vice versa.

7. The machine tool according to claim 1, wherein the first sections of the cavity structures are connected to the second sections of the cavity structures via through holes, and the openings of the through holes are closed on outside surfaces of the machine frame by covers.

8. The machine tool according to claim 1, further comprising a heat exchanger adapted to match a temperature of a process coolant which directly cools the machined area of a workpiece during a work process, with a temperature of the coolant.

9. The machine tool according to claim 1, wherein a pump for adjusting a volume flow of the coolant is provided inside the cavity structures, and an output of a pump and a cross-section of the cavity structures are configured such that a maximum temperature difference of the coolant between the first sections and the second sections can be adjusted to below 5° C. during operation.

10. The machine tool according to claim 5, wherein the cavity structures of the machine bed are arranged in parallel below the guideways and the column merely has any second areas.

11. The machine tool according to claim 6, wherein the cavity structures of the machine bed are arranged in parallel below the guideways and the column merely has any second areas.

12. A method for controlling a temperature of a machine frame of a machine tool having functional components that produce heat during the operation, said functional components being arranged on the machine frame which has cavity structures forming a circulation circuit where a coolant is circulated, the machine frame having first areas and second areas which are spaced apart from the first areas, a heat input into the second areas being less than that into the first areas, and the cavity structures having first sections which are arranged in the first areas and second sections which are arranged in the second areas, the method comprising:
compensating for a temperature drop between the first and second areas by circulating the coolant from the first sections into the second sections exclusively inside the machine frame.

13. A method for controlling a temperature of a machine frame of the machine tool according to claim 10, comprising:
compensating for a temperature drop between the first and second areas by circulating the coolant from the first sections into the second sections exclusively inside the machine frame.

14. A method for controlling a temperature of a machine frame of the machine tool according to claim 11, comprising:
compensating for a temperature drop between the first and second areas by circulating the coolant from the first sections into the second sections exclusively inside the machine frame.

15. The method for controlling a temperature of the machine frame of a machine tool according to claim 12, wherein the machine frame comprises a machine bed and a column that have cavity structures, and the method further comprises:
circulating the coolant for compensating for temperature differences from the cavity structures of the column into the cavity structures of the machine bed and back or vice versa.

16. A method for controlling a temperature of the machine frame of a machine tool according to claim 14, comprising:
circulating the coolant for compensating for temperature differences from the cavity structures of the column into the cavity structures of the machine bed and back or vice versa.

17. The method for controlling a temperature of the machine frame of a machine tool according to claim 12, comprising:
pumping the coolant through the first sections of the cavity structures of a machine bed of the machine frame,
pumping the coolant into the second sections of the cavity structures of a column of a machine portal of the machine tool and back, and then
pumping the coolant into the first sections of the cavity structures of a crossbar of the machine portal and then back into the second sections of the cavity structures of the column of the machine portal.

18. The method for controlling a temperature of the machine frame of a machine tool according to claim 12, comprising:
adapting a temperature of a process coolant which directly cools a machined area of a workpiece during a work process to a temperature of the coolant via a heat exchanger.

19. The method for controlling the temperature of the machine frame of a machine tool according to claim 12, wherein the machine frame comprises a bed, a crossbar, and a column, and the method further comprises:
circulating the coolant from the cavity structures of the column into cavity structures of the machine bed and back; and/or
circulating the coolant from the cavity structures of the column into the cavity structures of the crossbar and back.
